(19) United States
(12) Patent Application Publication
(10) Pub. No.: US 2015/0106211 A1
(43) Pub. Date: Apr. 16, 2015

(54) GRAPHICAL USER INTERFACE FOR ADVERTISING SYSTEM AND METHOD RELATING THERETO

(71) Applicant: MARTIAN LOGIC PTY LTD, Sydney NSW (AU)

(72) Inventor: Anwar Khalil, Sydney NSW (AU)

(21) Appl. No.: 14/391,632

(22) PCT Filed: Apr. 10, 2013
(86) PCT No.: PCT/AU2013/000367

§ 371 Date: Oct. 9, 2014

(30) Foreign Application Priority Data
Apr. 10, 2012 (AU) 2012901391

(51) Int. Cl. G06Q 30/02; G06F 3/0481; G06F 17/24

(52) U.S. Cl. CPC G06Q 30/0276; G06F 17/248; G06F 3/0481; G06F 17/243
USPC 705/14.72

(57) ABSTRACT

The present disclosure provides a computer-implemented graphical user interface for use in an advertising system. The computer-implemented graphical user interface for use in an advertising system comprises a template having a plurality of fields for receiving content relating to an advertisement, each field being prepopulated with a corresponding default value; wherein a first set of said fields is presented substantially in accordance with a layout of the advertisement. In one implementation, each of said default values is displayed in a default style and received values are displayed in a received style, said received style being different from said default style.

### CROSS-REFERENCE TO RELATED APPLICATIONS

This application is a national phase entry under 35 U.S.C. §371 of International Application No. PCT/AU2013/000367, filed 10 Apr. 2013, which claims the benefit of Australian Provisional Patent Application No. 2012901391 entitled “Graphical user interface for advertising system and method relating thereto” and filed on 10 Apr. 2012 in the name of Martian Logic Pty Limited, the entire contents of which are hereby incorporated by reference as if fully set forth herein.

### TECHNICAL FIELD

The present disclosure relates to a graphical user interface and, in particular, to a graphical user interface for use in an advertising system in an online environment.

### BACKGROUND

Vendors utilise advertisements to promote goods and services. Advertisements can be used across different media, including print media, billboards, bus signage, radio broadcasts, and television broadcasts. Print media includes newspapers and magazines.

Newspaper advertisements are sometimes referred to as “classifieds”, as the advertisements are grouped, or classified, into related goods or services. Thus, advertisements for cars for sale appear together, as do advertisements for jobs, and advertisements for real estate. Advertisements within a group may be further sorted, such as alphabetically or by price.

Hereinafter, a product may refer to either a good or service. In a traditional newspaper classified, a vendor wanting to advertise a product would provide a short description to the newspaper and the newspaper would publish the advertisement for an arranged fee. The short description provided by the vendor would typically include a title, content relating to the product, a price, and details for contacting the vendor. Newspapers commonly offer different classes of advertisements, available for different fees. A premium advertisement might appear in bold or be placed in a desirable part of the newspaper. Premium advertisements might also include a logo associated with the vendor.

In recent times, classified advertisements have appeared in the online environment of the Internet, wherein different World Wide Web (WWW) pages are used by advertising agencies to host classified advertisements. An agency website may host an advertisement for a vendor directly, whereby the vendor engages an administrator of the agency website to publish an advertisement. For example, a vendor wanting to advertise a house for sale may engage a real estate agent to advertise the house on an agency website administered by the real estate agent. The vendor provides to the real estate agent relevant information about the house for sale and the real estate agent then uploads that information in an appropriate format for publication on the agency website administered by the real estate agent. A disadvantage is that a potential purchaser has to search multiple agency websites to identify all of the relevant properties that are presently offered for sale. Examples of such agency websites include adecco.com.au, naimanclarke.com.au, raywhite.com.au, and ljhooker.com.au.

A portal website can be used to host advertisements relating to common subject matter, such as cars, jobs, or real estate. Thus, a real estate portal website hosts advertisements from multiple vendors, which may include real estate agents and private vendors. Examples of such portal websites include domain.com.au, realestate.com.au, drive.com.au, seek.com.au. mycareer.com.au, and careerone.com.au. A portal website hosting advertisements from multiple vendors facilitates the purchasing process for a potential customer. The potential customer accesses the portal website and views multiple products available for purchase from multiple vendors.

A vendor wanting to obtain maximum coverage for an advertisement may utilise one or more agency websites, one or more portal websites, or a combination thereof. However, different agency websites and portal websites may require content to be provided in a different format, which makes it difficult for the vendor to present the same advertisement in a consistent manner across the different websites. Further, agency websites may need to amend the content of their advertisements when providing content to different portal websites.

Agency websites and portal websites may provide a template for a user to complete in relation to a new advertisement. Such templates are typically presented as a plurality of blank fields with associated labels. The labels attempt to explain to the user what content is required to be provided in the corresponding field. A template may include one or more mandatory fields, which are commonly identified by using an identifier, such as underlining or an asterisk next to the label for those fields. The template may include a combination of field types, such as text fields, drop down lists, check boxes, combination boxes, large text areas, and large What You See Is What You Get (WYSIWYG) fields. The templates may span multiple pages of the website or require a user to scroll down multiple times to view and complete all of the fields.

Different agency websites and portal websites typically utilise different templates, even for the same or related subject matter. Further, different agency websites and portal websites utilise different fields to obtain the same content and may use different labels for the same or related content. The differences in the templates and the way in which the templates are presented to the vendor create difficulties for the vendor, as the vendor wanting to advertise with multiple agencies or portals must compose an advertisement for a product multiple times to satisfy the requirements of the different agency website and portal website templates. Further, the vendor must be educated as to what each field means in the template for each agency website and each portal website.

When a vendor is providing content to a template on an agency website or a portal website to create a new advertisement, the website does not save the advertisement until all of the mandatory fields have been completed and the vendor presses the submit button at the end of the process. Completing the whole template may take anywhere between 5 and 25 minutes, or longer, particularly as the vendor commonly needs time to refine the copy (content) of the new advertisement, and it is common for a vendor who is creating a new advertisement to be interrupted by other duties. Consequently, a new advertisement may be lost if, before pressing the submit button, an Internet connection drops out or if a website browser page used by the vendor to create the advertisement crashes. It is frustrating for the vendor to lose content that may have taken a significant amount of time to have entered and then to have to re-enter the information.

Thus, a need exists to provide an improved graphical user interface for use in an advertising system.

### SUMMARY

The present disclosure relates to a computer-implemented graphical user interface for use in an advertising system.

In a first aspect, the present disclosure provides a computer-implemented graphical user interface for use in an advertising system, comprising:
a template having a plurality of editable fields for receiving content relating to an advertisement, a first set of the fields being presented in an arrangement that corresponds substantially with a layout of the advertisement for publication;
wherein said arrangement includes at least one of: relative positions of the fields, sizes of the fields, and font of each field; and
further wherein each field is prepopulated with a corresponding default value, said default value being selected from the group consisting of: a dummy entry, a description of the field, an example of an entry for the field, and an instruction for completing the field.

In a second aspect, the present disclosure provides a method for receiving content relating to an advertisement in an advertising system, the method comprising the steps of:
creating an advertisement template having a plurality of fields;
pre-populating each field in the advertisement template with a corresponding default value, said default value being selected from the group consisting of: a dummy entry, a description of the field, an example of an entry for the field, and an instruction for completing the field;
storing the advertisement template;
presenting a first set of the fields in an arrangement that corresponds substantially with a publication layout for said advertisement, wherein said arrangement includes at least one of: relative positions of the fields, sizes of the fields, and font of each field;
while at least one of the fields remains pre-populated with the default entry:
   displaying the advertisement template;
   receiving content in one of the plurality of fields; and
   storing the advertisement with the received content as a created advertisement; and
storing the created advertisement with the received content as a complete advertisement.

In a third aspect, the present disclosure provides a computer readable storage medium having recorded thereon a computer program for receiving content relating to an advertisement in an advertising system. The computer program comprises code for performing the steps of:
creating an advertisement template having a plurality of fields;
pre-populating each field in the advertisement with a corresponding default value, said default value being selected from the group consisting of: a dummy entry, a description of the field, an example of an entry for the field, and an instruction for completing the field;
storing the advertisement template;
presenting a first set of the fields in an arrangement that corresponds substantially with a publication layout for said advertisement;
while at least one of the fields remains pre-populated with the default entry:
   receiving content in one of the plurality of fields; and
   storing the advertisement template with the received content as a created advertisement; and
storing the created advertisement with the received content as a complete advertisement.

In one example, each of the default values is displayed in accordance with a default style and each received value is displayed in accordance with a received style.

According to another aspect, the present disclosure provides an apparatus for implementing any one of the aforementioned methods.

According to another aspect, the present disclosure provides a computer program product including a computer readable medium having recorded thereon a computer program for implementing any one of the methods described above.

Other aspects of the invention are also disclosed.

### BRIEF DESCRIPTION OF THE DRAWINGS

One or more embodiments of the present disclosure will now be described by way of specific example with reference to the accompanying drawings, in which:

FIG. 1 is a screenshot of a graphical user interface template utilised by an agency website or a portal website;

FIG. 2 is a schematic block diagram representation of a system that includes a general purpose computer on which one or more embodiments of the present disclosure may be practised;

FIG. 3 is a flow diagram illustrating a method for obtaining content in an advertising system;

FIG. 4 is a schematic representation of a system on which one or more embodiments of a method for obtaining content in an advertising system may be practised;

FIGS. 5a-d are screenshots illustrating an example of a user interacting with a graphical user interface for receiving content relating to an advertisement;

FIG. 6 is a screenshot illustrating a completed job advertisement;

FIG. 7 is a screenshot illustrating a check box implemented selection mechanism by which a user can choose a set of online websites on which an advertisement is to be published;

FIG. 8 is a screenshot illustrating a dialog box that appears if a user attempts to submit an advertisement before all of the default entries have been replaced by user provided content;

FIG. 9 is a screenshot illustrating an example of a user interacting with a graphical user interface for receiving content relating to an advertisement; and

FIG. 10 is a flow diagram of a process for implementing steps 330, 335 of FIG. 3.

### DETAILED DESCRIPTION

Method steps or features in the accompanying drawings that have the same reference numerals are to be considered to have the same function(s) or operation(s), unless the contrary intention is expressed or implied.

The present disclosure provides a method and system for receiving content in an advertising system, wherein the content relates to an advertisement. The method and system provide a graphical user interface in the form of a template having a plurality of predefined fields, wherein each field is pre-populated with a corresponding default entry. The graphical user interface presents to a user a set of the plurality of fields in accordance with a layout corresponding substantially to how the advertisement is to appear.

Presenting a set of the plurality of fields in the same or similar layout as the advertisement is to appear provides a user with an intuitive interface in which to provide content relating to an advertisement.

In one implementation, each default entry provides a description of the corresponding field, such as “Title of the job”. In another implementation, each default entry provides one or more examples of an entry for that field, such as “e.g., Project Manager, Typist, . . . ”. In a further implementation, the default entry is a dummy entry, so that a user recognises that content has not yet been provided, such as “xxxxxxx”. In yet a further implementation, each default entry provides instructions to the user, such as “Enter the job title in this field”. In a yet further implementation, any combination of the above implementations may be utilised.

In one implementation, each default entry is presented in accordance with a default style. This allows a user to identify which fields have been completed and which fields still require content to be provided. The default style may include, for example, a default colour, a default font, or a combination thereof. The default style may relate to the presentation of the default entry, wherein a text box field, drop-down list, check box, or other input means associated with the default entry is presented in the default style. In such an implementation, the default style may include a background colour of the default entry, a border colour of the default entry, or a combination thereof. For example, a default entry may be presented with one or more of a coloured border, a coloured background, a patterned border, a patterned background, a flashing border, or other device that is readily recognised by the user as being associated with a default entry.

Presenting the default entries in a default style allows a user to recognise readily which fields have been completed by the user and which fields remain to be completed by the user.

The advertising system optionally pushes content relating to a created advertisement to one or more of a vendor website, an agency website, and a portal website. The pushed content may then be published on the receiving website(s). Alternatively, the advertising system may publish content relating to a created advertisement on a website or other interface associated with the advertising system.

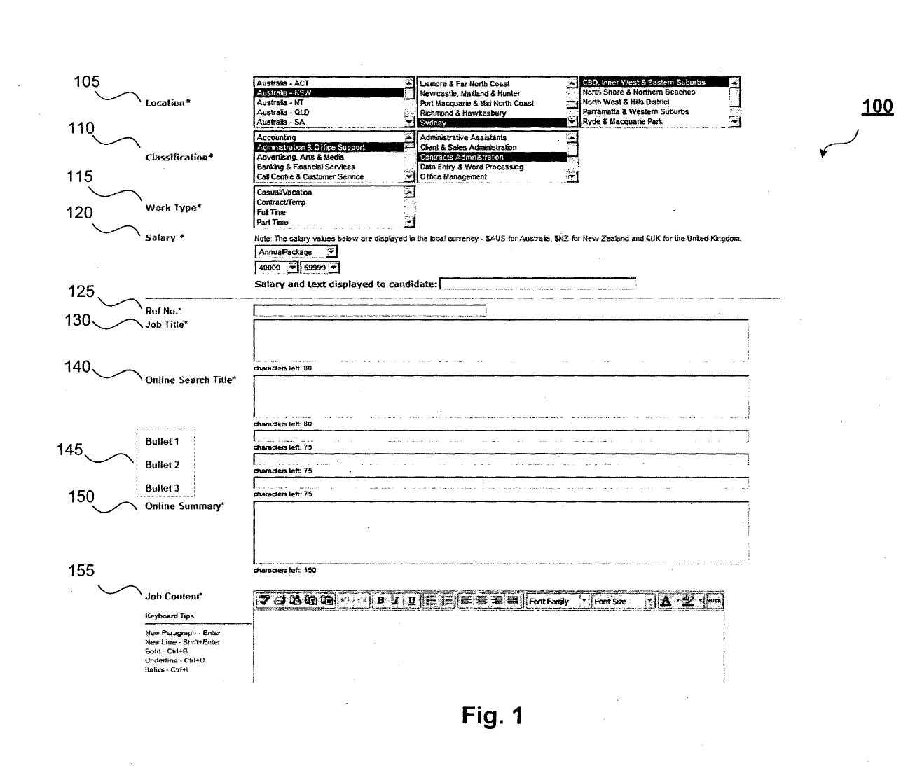

FIG. 1 is a screenshot of a graphical user interface 100 utilised by an agency website to receive content from a vendor relating to a job advertisement. A software application executing on a processor of a server hosting the agency website produces the interface 100 and displays the interface 100 as a template on a display device, such as a monitor, to the vendor when the vendor accesses the agency website to create a new job advertisement.

In this example, the interface 100 includes a plurality of fields, including: a Location field 105 implemented using a plurality of drop-down lists; a Classification field 110 implemented using a plurality of drop-down lists, a Work Type field 115 implemented using a drop-down list; and a Salary field 120 that allows the vendor to provide a bottom salary range and a top salary range.

The interface 100 also includes a Reference Number field 125, a Job Title field 130, an Online Search Title field 140, one or more optional Bullet point fields 145, an Online Summary field 150, and a Job Content field 155.

The mandatory fields that must be populated by the vendor before the advertisement can be completed are indicated by an asterisk. In this example, the mandatory fields include the Location field 105, the Classification field 110, the Work Type field 115, the Salary field 120, the Reference Number field 125, the Online Summary field 150, and the Job Content field 155.

Once the vendor has completed the mandatory fields and any of the optional fields of the vendor's choosing, the vendor submits the new job advertisement to the server hosting the agency website. The server receives the content and stores the new job advertisement with an identifier on a recordable storage medium, such as a hard disk or the like.

As is evident from FIG. 1, there is no indication provided to the vendor as to how the content that is entered into the respective fields will appear in the final advertisement. There is a level of knowledge required to provide the correct content in the relevant fields. Further, content that is entered into the interface 100 before submitting the advertisement to be saved and stored by the server may be lost due to a computer malfunction, browser timeout, communication link interruption, or the like. In such circumstances, the vendor must redo the entire process of creating the advertisement. This results in lost productivity and frustration.

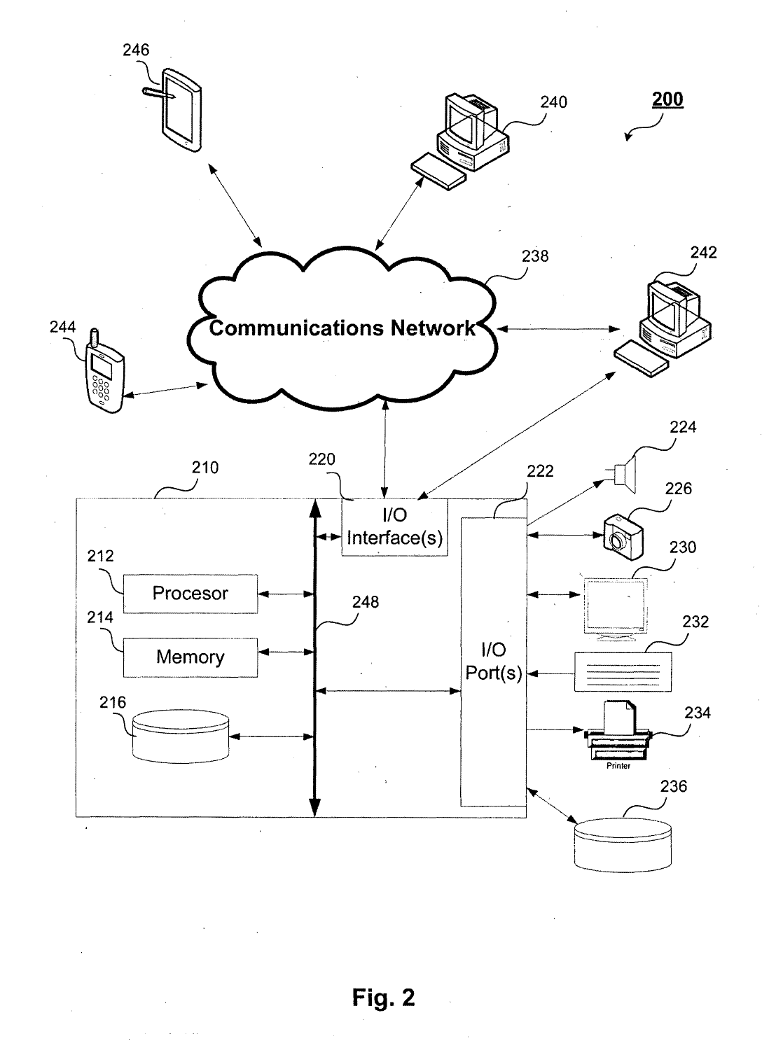

The graphical user interface of the present disclosure for receiving content in an advertising system may be practised using a computing device, such as a general purpose computer or computer server. FIG. 2 is a schematic block diagram of a system 200 that includes a general purpose computer 210. The general purpose computer 210 includes a plurality of components, including: a processor 212, a memory 214, a storage medium 216, input/output (I/O) interfaces 220, and input/output (I/O) ports 222. Components of the general purpose computer 210 generally communicate using a bus 248.

The memory 214 may include Random Access Memory (RAM), Read Only Memory (ROM), or a combination thereof. The storage medium 216 may be implemented as one or more of a hard disk drive, a solid state “flash” drive, an optical disk drive, or other storage means. The storage medium 216 may be utilised to store one or more computer programs, including an operating system, software applications, and data. In one mode of operation, instructions from one or more computer programs stored in the storage medium 216 are loaded into the memory 214 via the bus 248. Instructions loaded into the memory 214 are then made available via the bus 248 or other means for execution by the processor 212 to effect a mode of operation in accordance with the executed instructions.

One or more peripheral devices may be coupled to the general purpose computer 210 via the I/O ports 222. In the example of FIG. 2, the general purpose computer 210 is coupled to each of a speaker 224, a camera 226, a display device 230, an input device 232, a printer 234, and an external storage medium 236. The speaker 224 may include one or more speakers, such as in a stereo or surround sound system.

The camera 226 may be a webcam, or other still or video digital camera, and may download and upload information to and from the general purpose computer 210 via the I/O ports 222, dependent upon the particular implementation. For example, images recorded by the camera 226 may be uploaded to the storage medium 216 of the general purpose computer 210. Similarly, images stored on the storage medium 216 may be downloaded to a memory or storage medium of the camera 226. The camera 226 may include a lens system, a sensor unit, and a recording medium.

The display device 230 may be a computer monitor, such as a cathode ray tube screen, plasma screen, or liquid crystal display (LCD) screen. The display 230 may receive information from the computer 210 in a conventional manner, wherein the information is presented on the display device 230 for viewing by a user. The display device 230 may optionally be implemented using a touch screen, such as a capacitive touch screen, to enable a user to provide input to the general purpose computer 210.

The input device 232 may be a keyboard, a mouse, or both, for receiving input from a user. The external storage medium may be an external hard disk drive (HDD), an optical drive, a floppy disk drive, or a flash drive.

The I/O interfaces 220 facilitate the exchange of information between the general purpose computing device 210 and other computing devices. The I/O interfaces may be implemented using an internal or external modem, an Ethernet connection, or the like, to enable coupling to a transmission medium. In the example of FIG. 2, the I/O interfaces 222 are coupled to a communications network 238 and directly to a computing device 242. The computing device 242 is shown as a personal computer, but may be equally be practised using a smartphone, laptop, or a tablet device. Direct communication between the general purpose computer 210 and the computing device 242 may be effected using a wireless or wired transmission link.

The communications network 238 may be implemented using one or more wired or wireless transmission links and may include, for example, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a mobile telephone cellular network, a short message service (SMS) network, or any combination thereof. The general purpose computer 210 is able to communicate via the communications network 238 to other computing devices connected to the communications network 238, such as the mobile telephone handset 244, the touchscreen smartphone 246, the personal computer 240, and the computing device 242.

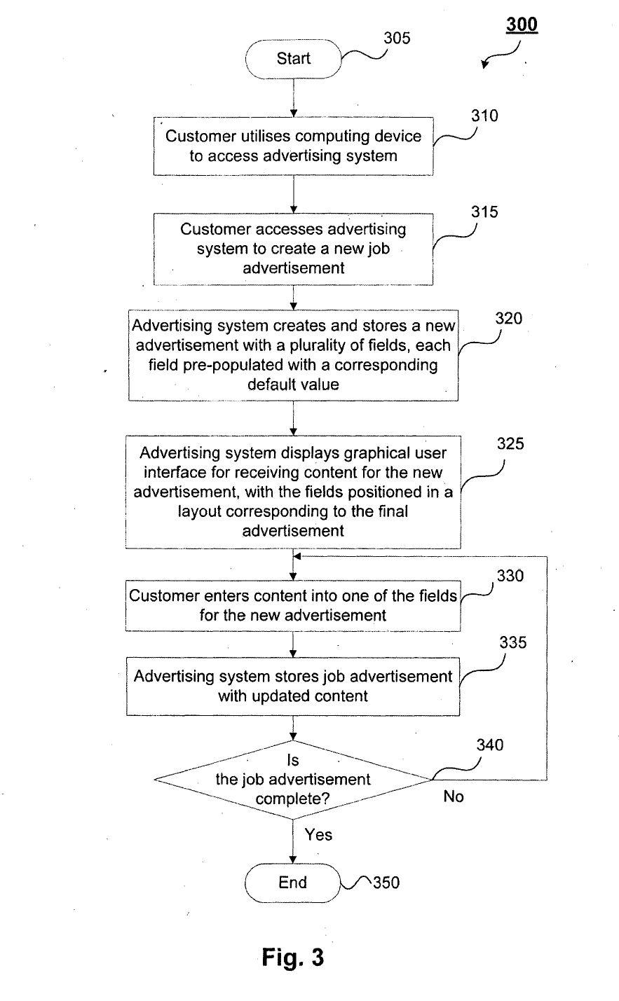

FIG. 3 is a flow diagram illustrating a method 300 for receiving content for an advertisement in an advertising system. The example of FIG. 3 relates to the creation of an advertisement of a job using an advertising system. It will be appreciated by a person skilled in the art, however, that the method may equally be practised in relation to advertisements for any other product, without departing from the spirit and scope of the present disclosure.

The advertising system is accessible by customers to create advertisements relating to products. In one implementation, the advertising system includes a website hosted on a server. In an alternative implementation, the advertising system is configured in a client/server arrangement. The advertising system may include a software application executing on a computing device utilised by a customer, such as a plug-in on a browser or an application executing on a mobile computing device. Customers may include individual vendors, who have a direct connection to the product that is to be advertised, and agencies, who are engaged by a vendor to market the product that is to be advertised. As noted above, the example of FIG. 3 relates to the creation of an advertisement for a job. In such an example, the customer may be a vendor in the form of a company that owns the job position that is to be advertised. Alternatively, the customer may be a recruitment agency engaged by a company that owns the job position that is to be advertised.

The method 300 begins at a Start step 305 and proceeds to step 310, in which a customer wanting to create an advertisement utilises a computing device to establish communication with an advertising system. In this example, the advertising system includes a website hosted on a server executing a software application for implementing the advertising system. In this example, the advertisement relates to a job, but it will be appreciated that the advertisement may equally relate to real estate, cars, or other products.

Control then proceeds from step 310 to step 315, in which the customer sends a request to the advertising system to create a new job advertisement. In step 320, the advertising system creates and stores a new advertisement that includes a plurality of fields. Each of the plurality of fields is pre-populated with a corresponding default value. In one implementation, the corresponding default values are predefined by an administrator of the advertising system. In an alternative implementation, the corresponding default values are predefined by the customer, so that all of the advertisements created by that customer have a similar appearance.

Control passes from step 320 to step 325, which presents to the customer on a display of the computing device a graphical user interface for receiving content for the new advertisement. The graphical user interface presents the new advertisement as a template having a layout corresponding to how the advertisement is to appear. That is, a first set of the plurality of pre-populated fields of the new advertisement is presented to the user in an arrangement that corresponds substantially to how the final advertisement will appear when published. The arrangement may include, for example, but is not limited to, the relative positions of the fields, the size of the fields, the font of each field, and the size and position of any logos.

In one example, each default value entry is displayed in a default style. The default style may include, for example, at least one of a predefined colour and a predefined font. In one example, each default entry is displayed in a default style that includes the colour brown. Further, the default entry for a field may include a description of that field. Consequently, a customer creating an advertisement can readily ascertain which fields require content to be provided and the nature of the content that is to be provided.

In one implementation, a submit button associated with the advertisement is disabled until all of the fields in the advertisement have received content from the customer. If the customer thinks the advertisement is complete, but the submit button is disabled to indicate that at least one field still requires content to be provided by the customer, the customer is able to scan the advertisement and readily recognise the field or fields that still require content, as each of those fields will still contain the corresponding default entry presented in accordance with the default style.

In one implementation, the advertising system provides a tabulated list of fields associated with an advertisement, wherein the tabulated list indicates which fields have been completed and which fields remain to be completed. The tabulated list may be displayed in a portion of a display screen. In a simplified version, the tabulated list only includes the fields that remain to be completed. In one embodiment, the fields in the tabulated list include links to fields in the advertisement that remain to be completed. Accordingly, a customer can click on a field appearing in the tabulated list and be taken to a field in the advertisement for which content needs to be provided.

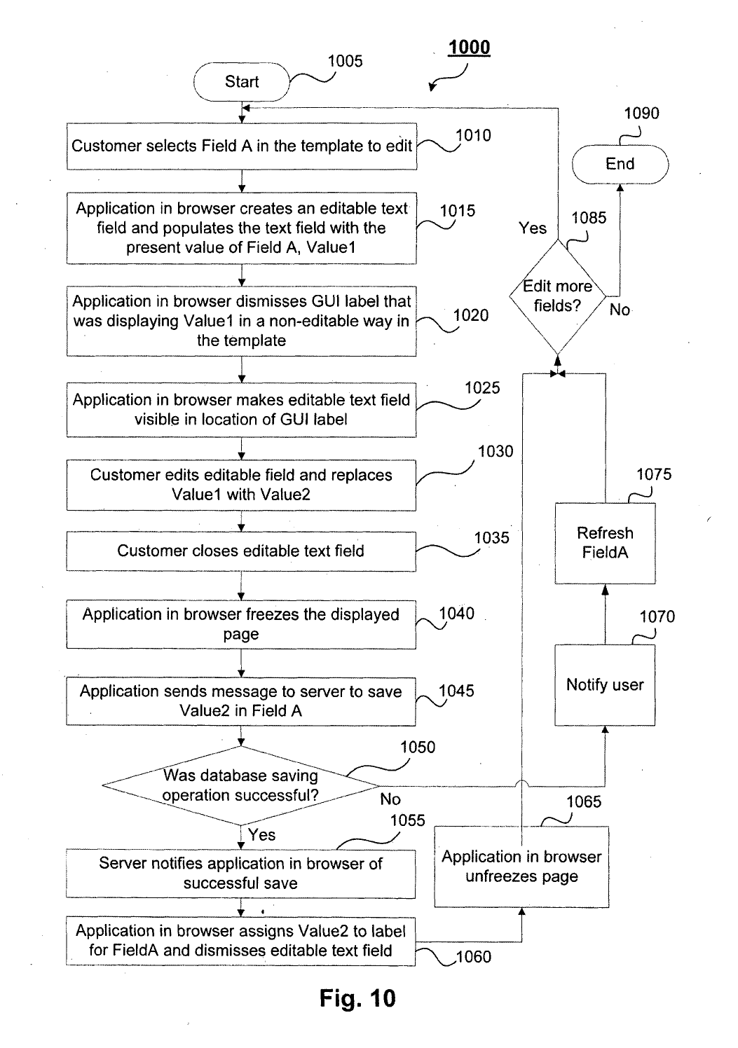

Control passes from step 325 to step 330, in which the customer uses an input device of the computing device to enter content into one of the fields. In one implementation, the customer utilises a mouse pointing device to click on a field and an editable text box is provided to receive content from the customer for that field. Further detail relating to an example of such an implementation is provided with reference to FIG. 10. In another implementation, the user utilises a mouse pointing device to click or double-click on a field to generate a popup window to receive content from the customer for that field. In a further implementation, a combination of editable text fields and popup windows is utilised to receive content from a customer for one or more of the fields. The content received from the customer for that field is transmitted from the computing device to the server. The server receives the content and stores an updated version of the advertisement with the newly received content. In this way, the advertisement is constantly updated and stored as each entry is completed by the customer. If an interruption to service occurs, such as a browser fault, the customer only risks losing information relating to the field presently being entered.

Control passes from step 330 to step 335, in which the advertising system stores the advertisement with the content provided by the customer in step 330. Content provided by the customer may subsequently be displayed in a received style that is different from the default style, so as to assist the customer in recognising which fields remain to be completed.

Control passes from step 335 to decision step 340, which determines whether the job advertisement is complete. In one implementation, step 340 is performed by the advertising system checking whether the customer has pressed a “submit” button, or similar, to finalise the advertisement or by verifying whether any of the fields remain populated with a default value. In another implementation, the advertising system disables the “submit” button until all of the fields in the advertisement have received content from the customer. If the advertisement is not complete, No, control returns to step 330 for the customer to provide content to one of the plurality of fields. However, if at step 340 the advertisement is complete, Yes, control passes from step 340 to an End step 350 and the method 300 terminates.

Once the advertisement has been created on the advertising system, the advertising website optionally pushes the created advertisement to one or more external websites or servers for publication. Such external websites and servers may include a website or server associated with a vendor, an agency website, a portal website, or any combination thereof. Alternatively, the advertising system may publish the advertisement, alone or in combination with any of the external websites or servers.

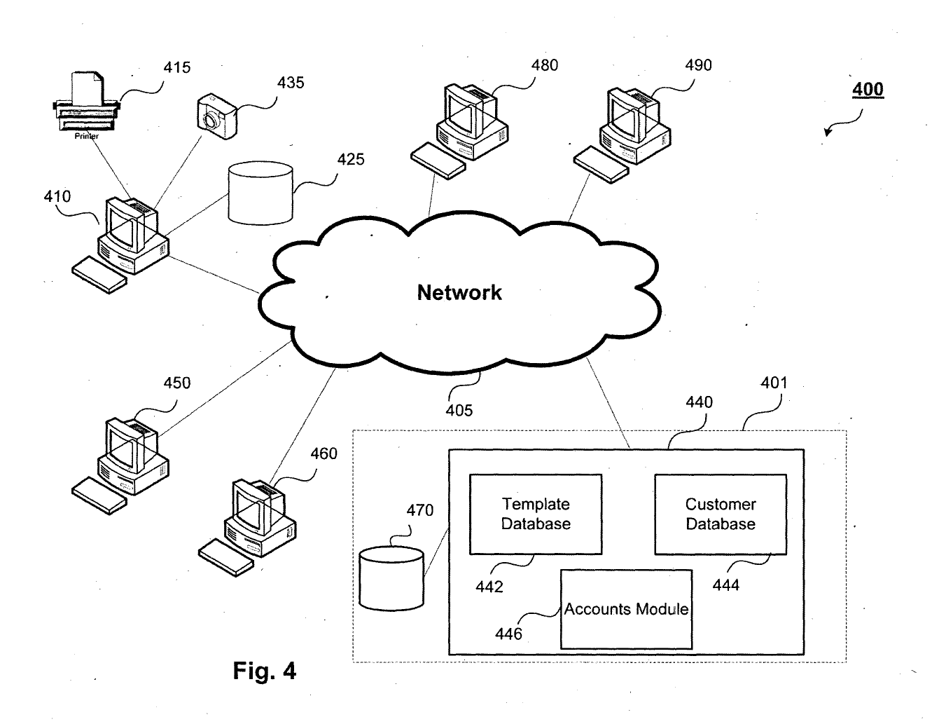

FIG. 4 is a schematic representation of an advertising system 400 on which embodiments of the present disclosure may be practised. The system 400 includes an advertising system 401 hosted on a server 440. In this example, the server 440 hosts an advertising system relating to job advertisements. The server 440 may be implemented using one or more general purpose computing devices 210 and associated internal or external storage media. In this example, the server 440 is associated with an external database 470.

The advertising system 401 includes a customer database 444 for storing details associated with customers that advertise using the advertising system 401. In one implementation, the customer database 444 includes a profile for each customer, wherein each profile includes information relation to that customer. The profile may include, for example, name, address, company number, and billing details. The advertising system 401 also includes an accounting module 446 for handling accounts relating to customers and external website providers. The advertising system 401 further includes a template database 442 for storing predefined templates for use in advertisements. Different templates may be utilised, for example, for different industries, different customers, and different payment plans.

For example, a customer may have developed a particular format for job advertisements and that customer then wants all job advertisements relating to that customer to appear in the same format. Accordingly, when that customer accesses the advertising system 401 to create a new advertisement, the advertising system 401 recognises the customer, based on username, Internet Protocol (IP) address, or the like, and retrieves an appropriate template from the template database to be used in creating a new advertisement for that customer.

The server 440 hosting the advertising system 401 is connected to a communications network 405. The communications network 405 may include, for example, one or more wired or wireless connections, including a Local Area Network (LAN), Wide Area Network (WAN), a virtual private network (VPN), cellular telephony network, the Internet, or any combination thereof.

The system 400 also includes a computing device 410 coupled to the communications network 405. The computing device 410 may be implemented using a smartphone, laptop, desktop computer, server, or general purpose computer, such as the general purpose computer 210 of FIG. 2. The computing device 410 in the example of FIG. 4 is coupled to a printer 415, a camera 435, and a database 425. The camera 435 may be utilised to upload images relating to a product that is to be advertised, for example.

In the example of FIG. 4, a company, Company X, wants to advertise a new job position that has become available. A user, in the form of an authorised officer of Company X, utilises the computing device 410 to establish communication over the communications network 405 with the advertising system 401 hosted by the server 440.

The user utilises the computing device 410 to send a request to the advertising system 401 hosted by the server 440 to create a new advertisement. Depending on the implementation, the advertising system 401 may require the company to register as a user of the advertising system. Such registration may require the user to provide contact and billing details in exchange for the advertising system 401 allocating a username and password to access the advertising system. The advertising system 401 receives the request from the computing device 410 via the communications network 405 and creates a new job advertisement in accordance with any criteria presented in the request. Such criteria may include, for example, a predefined template that is to be used in the advertisement. The new job advertisement created by the server 440 includes a plurality of fields, wherein each field is populated with a default entry. The default entry may be a dummy entry, a descriptive entry, an instructive entry, an example, or any combination thereof. In this example, each default entry provides a brief description of the relevant field. In this example, each default entry is presented in a default style, to assist the user in distinguishing which fields include content provided by the user. The default style may include a predefined colour, predefined font, or a combination thereof.

The advertising system 401 stores the new job advertisement in the database 470 and then presents the new job advertisement to a display of the computing device 410. The new job advertisement is displayed using a graphical user interface that presents the new job advertisement in a layout that corresponds to how the advertisement is to appear. Presenting the fields in a layout that corresponds to how the advertisement is to appear provides an intuitive interface for the user.

The user utilises an input device of the computing device 410 to select a field of the graphical user interface to edit. When the user has provided the content and utilised a keyboard of the computing device 410 to select “Tab” or “Enter” or used a mouse pointing device to move to another field of the graphical user interface and indicate that the field is complete, the provided content is transmitted via the communications network 405 to the advertising system 401. The advertising system 401 stores the provided content in an updated version of the new advertisement. By storing the advertisement each time a field is edited, the user is less susceptible to outages or faults that may occur during creation of the advertisement.

The advertising system 401 then presents the updated advertisement to the user using the same graphical user interface. In an implementation in which a default entry is presented in a default style, the entry that the user has edited is now presented in a received style, the received style being different from the default style to enable the user to distinguish between the provided content and the default entries.

The received style may include, for example, a received colour, a received font, or a combination thereof. The received style may relate to the presentation of the received entry, wherein a text box field, drop-down list, check box, or other input means associated with an entry received from the user is presented in the received style. In such an implementation, the received style may include a background colour of the received entry, a border colour of the received entry, or a combination thereof. For example, a received entry may be presented with one or more of a coloured border, a coloured background, a patterned border, a patterned background, a flashing border, or other device that is readily recognised by the user as being associated with a received entry. Presenting the default entries in a default style and the received entries in a received style that is different from the default style allows a user to recognise readily which fields have been completed by the user and which fields remain to be completed by the user.

For example, in one implementation the default entries are presented in a default style that includes a brown font. When a user provides content to a field, the provided content is displayed in a received style, which in this example includes a black font. Consequently, the user can readily recognise brown content as default entries and black content as content provided by the user.

The user continues to edit the job advertisement, with the advertisement being stored by the advertising system 401 each time the user edits a single field. When the user is satisfied that the job advertisement is complete, the user presses a submit button and the advertising system 401 finalises the job advertisement for publication. The advertisement may be published by the advertising system 401 hosted by the server 440. In such an implementation, a person looking for a job can browse the available job advertisements published on the advertising system 401. Alternatively, the advertising system 401 may provide advertising content to a website or job board associated with the customer, one or more agency websites, one or more portal websites, or a combination thereof.

The system 400 also includes agency websites hosted on servers 450 and 460 connected to the communications network 405. Each of the servers 450, 460 is implemented using an instance of the general purpose computing device 210 of FIG. 2. In this example, the agency website hosted by server 450 is administered by Recruitment Company A and the agency website hosted by server 460 is administered by Recruitment Company B. The system 400 also includes portal websites hosted on servers 480 and 490 connected to the communications network 405. Each of the servers 480, 490 is implemented using an instance of the general purpose computing device 210 of FIG. 2. In this example, the portal website hosted by server 480 is administered by Portal Company C and the portal website hosted by server 490 is administered by Portal Company D.

The advertising system 401 hosted by the server 440 optionally pushes advertising content to one or more of the agency websites administered by Recruitment Company A and Recruitment Company B and the portal websites administered by Portal Company C and Portal Company D, via the communications network 405, based on instructions from customers of the advertising system 401. The advertising system 401 may also push advertising content to a website of a customer, such as to a jobs board as part of a website of Company X hosted on computing device 410.

In addition to creating and finalising the job advertisement, the user indicates where the advertisement is to be published. The user optionally indicates when the advertisement is to be published, such as by providing a range of dates, or a period of advertisement (e.g., 30 days). When a user specifies a period of advertisement or range of dates, the user is generally free to cease the publication of the advertisement at any time, such as when a job position has been filled or a product sold. In the example of FIG. 4, the user indicates that the job advertisement is to be published on the agency website administered by Recruitment Company B, and on the portal websites administered by Portal Company C and Portal Company D, during an advertising period from 1 May 2012 to 1 Jun. 2012. After the user finalises and approves the job advertisement, the advertising system 401 transmits the job advertisement to each of the server 460, the server 480, and the server 490 for publication between 1 May 2012 and 1 Jun. 2012. During the advertising period, the agency website administered by Company B and the portal websites administered by Portal Company C and Portal Company D display the job advertisement created by the officer of Company X.

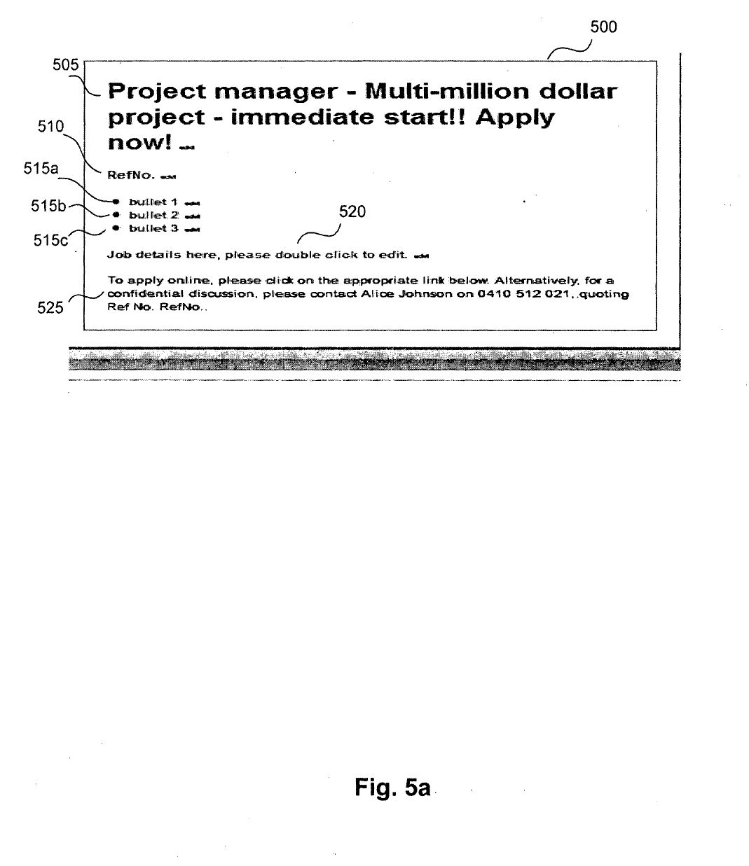

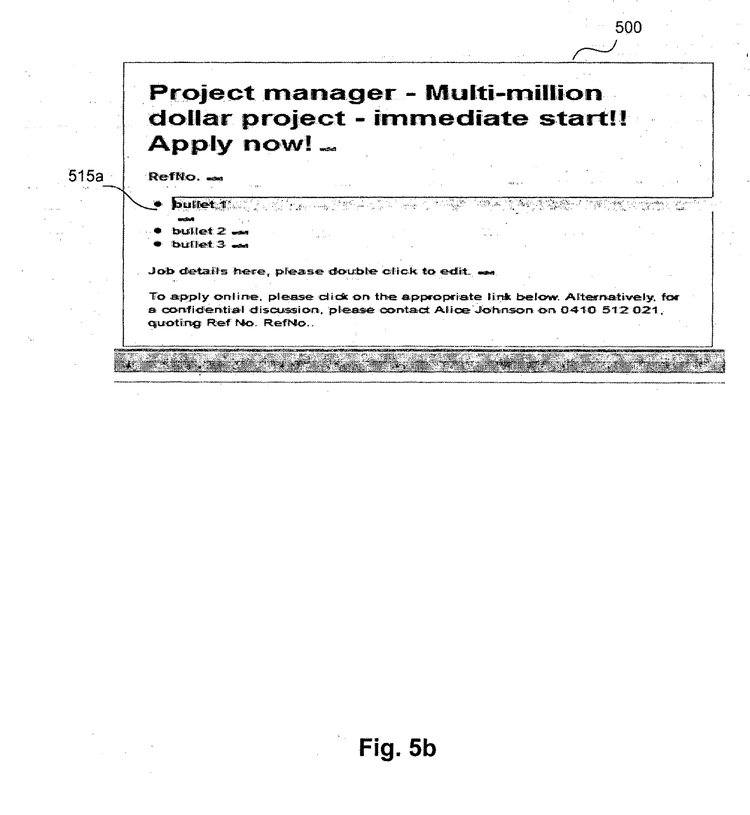

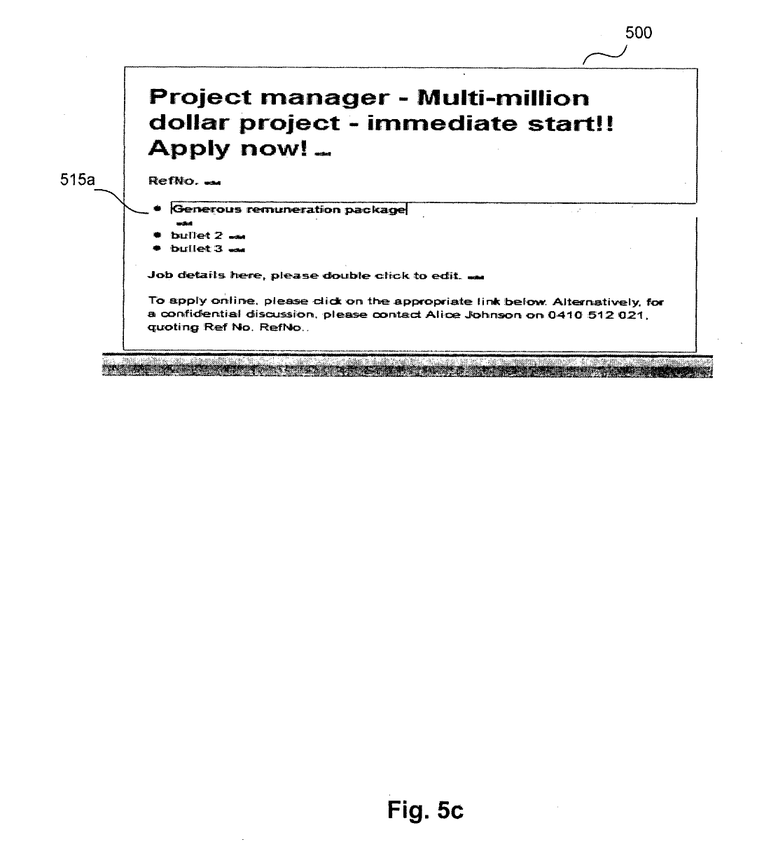

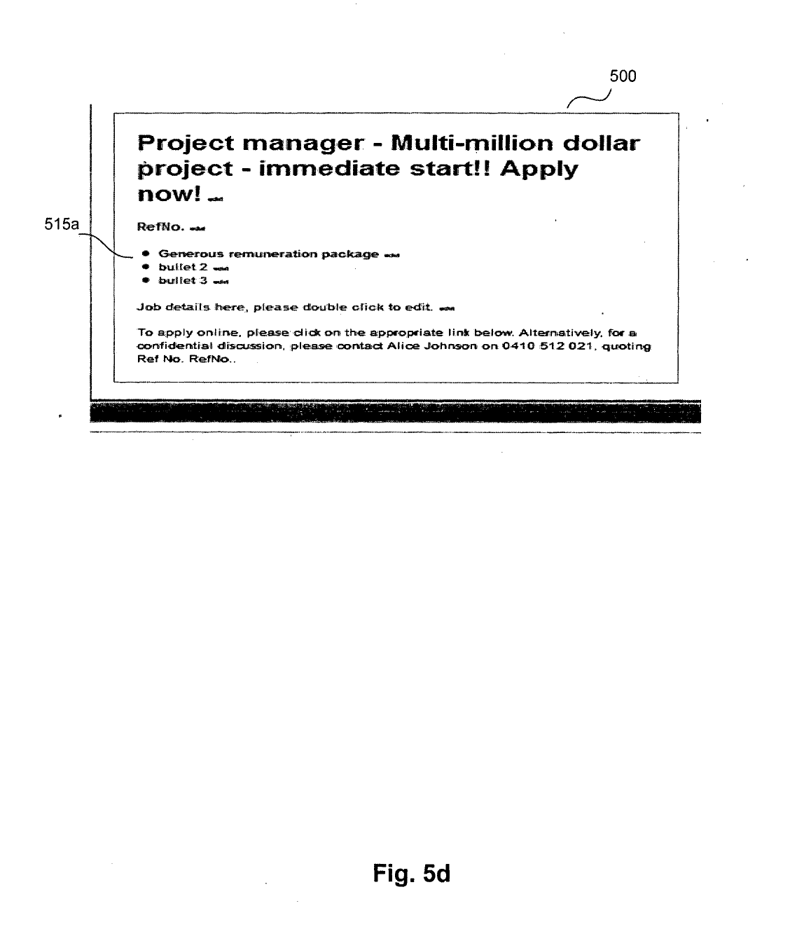

FIGS. 5a, 5b, 5c, and 5d are screenshots illustrating an example of a user interacting with a graphical user interface for receiving content relating to an advertisement. In this example, the advertisement relates to a job advertisement for a Project Manager. FIG. 5a shows a template 500 presented by the graphical user interface. The template 500 includes a plurality of fields, including a Title field 505, a Reference Number field 510, a bullet point 1 field 515a, a bullet point 2 field 515b, a bullet point 3 field 515c, a Job Details field 520, and a Contact field 525. The Title field 505 has been populated by the user with “Project manager—Multi-million dollar project—immediate start!! Apply now!” and the populated content appears in black font. Similarly, the Contact field 525 has been populated by the user and the content in the Contact field 525 appears in a received style, which in this example is a black font. The remaining fields are pre-populated with default entries and appear in a default style, which in this example is a brown font. The fields are presented in a layout that represents substantially how the final advertisement will appear.

FIG. 5b shows the template 500 of FIG. 5a and illustrates the effect of the user editing the bullet point 1 field 515a. The user selects the bullet point 1 field 515a by clicking on that field or otherwise navigating to that field. Bullet point 1 field 515a turns into a text field that allows the user to enter content for that field.

Bullet point fields are used in advertisements to attract the attention of a reader and highlight one or more key aspects of the advertised product. In this case, the user wants to highlight that the advertised job offers a generous remuneration package. In FIG. 5c, the user enters “Generous remuneration package” into the bullet point 1 field 515a. When the user has finished entering content into the bullet point 1 field 515a, the user clicks outside the field 515a or selects another field in the template 500. At that time, the content provided by the user is transmitted to the advertising system that provides the graphical user interface and the advertising system stores an updated version of the job advertisement 500. In one implementation, the advertising system is implemented using the server 440 of FIG. 4 and the server saves the value of the bullet point 1 field 515a to the database 470, such as by using Asynchronous JavaScript and XML (AJAX) technology. If the entered value is successfully stored in the database 570, the server 440 updates the graphical user interface template 500 presented to the user to show the content of bullet point 1 field 515a in black font. FIG. 5d shows the updated template 500 with the content added to bullet point 1 field 515a and the content in field 515a is presented in the received style, which in this example is a black font.

The user continues to add content to the advertisement during the creation process. Each time a field is edited and completed, the computing device utilised by the user transmits the updated advertisement, or a portion thereof, to the server 440. The server 440 stores the updated advertisement in the database 440 and then indicates that the field has been stored by updating the template 500 displayed to the user such that the template 500 shows the stored content in black font. Once the user has provided content to each field in the template 500, the template 500 no longer shows any content in the default style indicated by a brown font.

FIG. 10 is a flow diagram illustrating a method 1000 for implementing steps 330 and 335 of FIG. 3, for an advertising system to store updated content as a user provides content to a field of the template. In creating an advertisement using the advertising system 401, a user edits a single field at a time, as described with reference to step 330 of FIG. 3.

The method 1000 begins at a Start step 1005, in which a customer that is creating an advertisement views an advertisement template provided by the advertising system 401. The template is presented to the customer as a page in a browser and displayed on a display device 230 of a computing device 410. The browser may be, for example, Internet Explorer, Mozilla Firefox, Google Chrome, or any other suitable browser. The page is based on content delivered from the advertising system 401. An advertising application downloaded to the computing device 410 from the advertising system 401 works in conjunction with the browser to control information presented to the user in the page that is being viewed.

The template displayed to the customer includes a plurality of predefined fields. At this stage of the process, the content of each field is displayed as a graphical user interface (GUI) label, such as an HTML label, and is not editable.

Control passes from step 1005 to step 1010, in which the customer utilises an input device of the computing device 410 to select a field in the template to edit. In this example, the customer selects a field called Field A by utilising a mouse pointing device to click on the label corresponding to Field A. Control passes from step 1010 to step 1015, in which the advertising application in the browser creates an editable text field and populates the text field with the present value of Field A, Value1.

Control passes from step 1015 to step 1020, in which the advertising application in the browser dismisses the GUI label that was displaying Value1 in a non-editable fashion in the template. The browser dismisses the GUI label by hiding that GUI label or deleting that GUI label.

In step 1025, the advertising application in the browser makes the editable text field created in step 1015 visible in the page displayed by the browser, at the same location previously occupied by the GUI label for Field A. Control passes from step 1025 to step 1030, in which the customer edits the editable text field that is now displayed in the location previously occupied by the GUI label for Field A. In this example, the customer replaces the former value, Value1, with a new value, Value2. Value2 may be a new value or may be an edited form of Value1.

In step 1035, the customer closes the editable text field, by utilising the mouse pointing device to click outside the editable text field, pressing “Enter” or “Tab” on a keyboard 232 of the computing device 410, or by other means. Control passes from step 1035 to step 1040, in which the advertising application in the browser freezes the displayed page. In step 1045, the advertising application sends a message to the server 440 hosting the advertising system 401. The message requests that the server 440 saves Value2 in Field A. In one implementation, the message is sent using AJAX or any other asynchronous protocol/platform that enables client side scripting, such as Javascript or VB script, to interact with the server side code/application without any interruption to the user experience.

Decision step 1050 determines whether Value2 has been successfully stored in the database 470 in the location corresponding to Field A. If the database save was successful, Yes, control passes to step 1055, in which the server 440 transmits a notification message to the computing device 410 via the communications network 405 to inform the advertising application in the browser executing on the computing device 410 of the successful database save. In step 1060, the advertising application in the browser assigns the Value2 to a GUI label for Field A and dismisses the editable text field. In step 1065, the application in the browser unfreezes the page and control passes to decision step 1085 to determine whether the customer wants to edit further fields. If the customer does want to edit further fields, Yes, control returns to step 1010 to allow the customer to edit further fields in the advertising template. If the customer does not want to edit further fields, No, control passes to an End step 1090 and the method 1000 terminates.

Returning to step 1050, if the database saving was not successful, No, control passes from step 1050 to step 1070, in which the server 440 sends a notification message via the communications network 405 to the computing device 410. The notification message is displayed by the browser to alert the customer that the database saving as unsuccessful. Control passes from step 1070 to step 1075, which refreshes Field A and unfreezes the page. In one implementation, refreshing Field A involves restoring the GUI label corresponding to Value1. In another implementation, refreshing Field A involves displaying the editable text field to the customer with Value2 presented in the editable text field, to allow the customer a further attempt to save the new content for Field A. Control passes from step 1075 to step 1085 to determine whether the customer wants to edit further fields. If the customer does want to edit further fields, Yes, control returns to step 1010 to allow the customer to edit further fields in the advertising template. If the customer does not want to edit further fields, No, control passes to an End step 1090 and the method 1000 terminates.

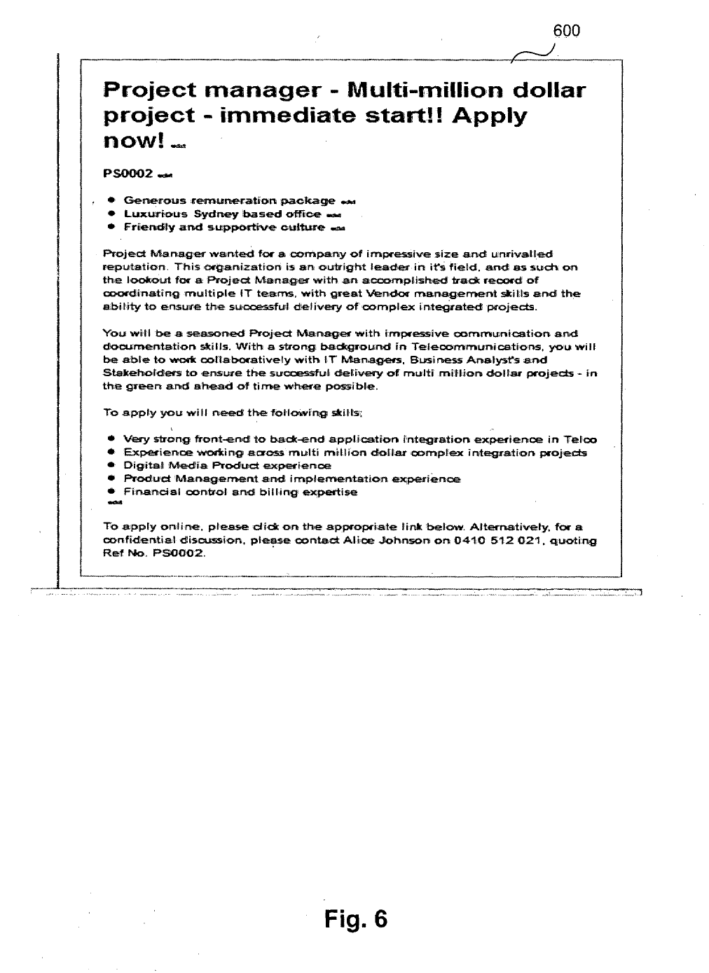

FIG. 6 is a screenshot 600 illustrating a completed job advertisement once the user has provided content for each of the fields in the template 500. Now that the advertisement has been completed by the user and there are no longer any fields displaying the pre-populated default entries, the server 440 makes the completed advertisement available for publication. The completed advertisement can be posted, as master copy for a job advertisement, to one or more online websites. The online websites may include, for example, a website associated with the user, classified job-boards, social media sites such as Twitter and Facebook, agency websites, portal websites, and the like.

In the example described above with reference to FIG. 4, the advertising system 401 hosted on the server 440 provides content to one or more agency websites, such as those hosted on the servers 450, 460, one or more portal websites, such as those hosted on the servers 480, 490, and websites associated with vendors, such as on a website hosted by the computing device 410. As part of the process of a user creating an advertisement on the advertising system 401, the user provides to the advertising system 401 a set of online websites on which the advertisement is to be published.

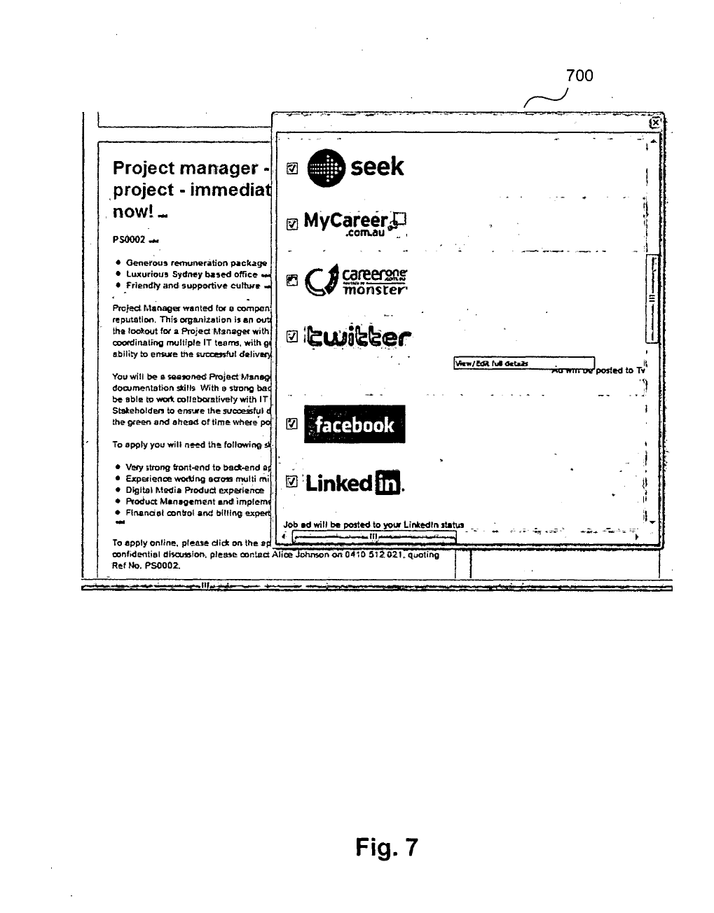

FIG. 7 is a screenshot 700 illustrating a check box implemented selection mechanism by which the user can choose a set of online websites on which the advertisement is to be published. In the example of FIG. 7, a plurality of online websites is provided, including: portal websites seek.com.au, MyCareer.com.au, and careerone.com.au; and social media websites Twitter, Facebook, and LinkedIn. Each of the online websites is displayed with an associated check box and the user chooses a set of websites for the advertisement by selecting one or more of the check boxes. In the example of FIG. 7, the user has selected a set of online websites that includes the portal websites seek.com.au and MyCareer.com.au and the social media websites Twitter, Facebook, and LinkedIn. In response to the user selecting the set of online websites, the advertising system 401 posts the job advertisement to each online website in the set of selected online websites, along with any other prescribed information, such as an advertising period. Each of the online websites in the set of selected online websites receives the job advertisement from the server 440 via the communications network 405 and publishes the job advertisement in accordance with the prescribed information.

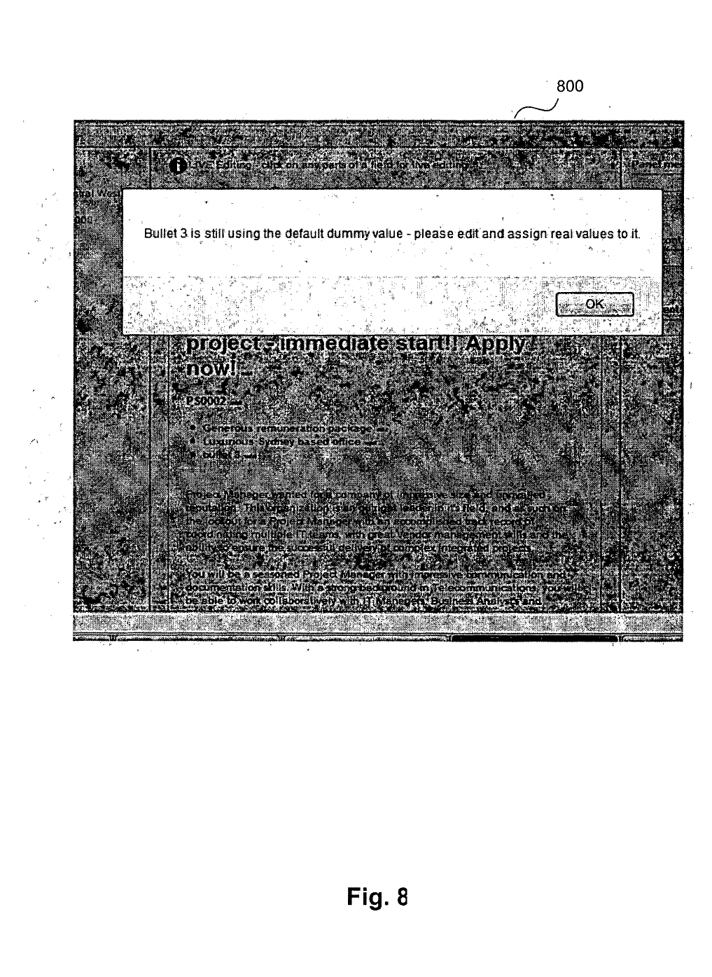

FIG. 8 is a screenshot illustrating a dialog box 800 that appears if a user attempts to submit an advertisement to the advertising system 401 before all of the default entries have been replaced by user provided content. In this example, the dialog box 800 alerts a user that bullet point 3 field 515c has not been completed with real content. This would be readily visible to the user, as the content of bullet point 3 field 515c would still be represented in the default style, such as a brown font.

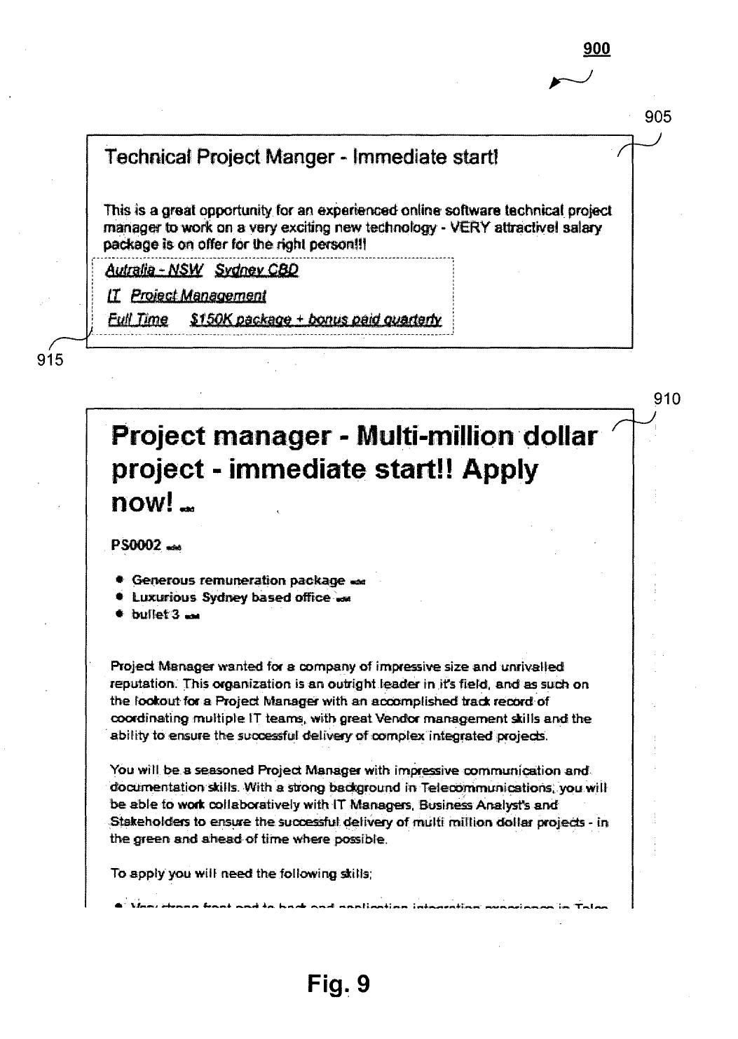

FIG. 9 is a screenshot 900 illustrating an alternative embodiment of a graphical user interface for receiving content relating to an advertisement. The screenshot 900 includes an advertisement template 910 similar to the template 500 described with reference to FIGS. 5a-d. The template 910 includes a plurality of fields arranged in a layout corresponding to how the fields will appear in a final advertisement for publication. In the example of FIG. 9, the advertisement template 910 has been completed as an advertisement for a job.

Agency websites and portal websites typically provide some form of search functionality to allow a user to search for advertisements based on criteria selected by the user. Such criteria varies depending on the particular application. For real estate advertisements, the criteria may include, for example, one or more of location, property type, number of bedrooms, number of bathrooms, number of car spaces, upper price, lower price, and amenities. For job advertisements, the criteria may include, for example, one or more of salary, location, full-time or part-time, and associated benefits. For car advertisements, the criteria may include, for example, mileage, age of vehicle, upper price, lower price, location, and private sale or dealer sale.

Search results are provided to a user in a compressed format. In some implementations, the administrator of a website parses content of an advertisement to provide the content for the search results, which may include a portion of the full title and a portion of the description. In an alternative implementation relating to the advertising system of the present disclosure, a user provides a search title and search description when creating an advertisement. This allows a user to decide what information will be displayed to a potential customer when searching a website.

In the example of FIG. 9, the screenshot 900 includes a separate portion 905 for the user to enter information relating to the search title and the search description. This allows the user to visualise how the advertisement will be displayed in the search results if the advertisement matches the search criteria supplied by a customer.

The screenshot 900 also includes an optional further portion 915 as part of the portion 905, wherein the further portion 915 provides brief details relating to the advertisement. In the example of FIG. 9, the further portion 915 includes brief details about the job advertisement detailed in the template 910. The brief details may include, for example, in relation to a job advertisement, location, industry, work type, and remuneration. Different brief details may be included for advertisements relating to different products. The brief details in the example of FIG. 9 include “Australia—NSW”, “Sydney CBD”, “IT”, “Project Management”, “Full Time”, “$150K package+bonus paid quarterly”. The brief details provided in the further portion 915 may optionally be included in search results provided to a user browsing a website, along with the search title and search description populated in the portion 905.

Although the invention has been described with reference to specific examples, it will be appreciated by those skilled in the art that the invention may be embodied in many other forms.

1. A computer-implemented graphical user interface for use in an advertising system, comprising:
a template having a plurality of editable fields for receiving content relating to an advertisement, a first set of said fields being presented in an arrangement that corresponds substantially with a layout of the advertisement for publication;
wherein said arrangement includes at least one of: relative positions of the fields, sizes of the fields, and font of each field; and
further wherein each field is prepopulated with a corresponding default value, said default value being selected from the group consisting of: a dummy entry, a description of the field, an example of an entry for the field, and an instruction for completing the field.

2. The computer-implemented graphical user interface of claim 1, wherein each of said default values is displayed in a default style.

3. The computer-implemented graphical user interface of claim 2, wherein said default style includes at least one of a colour, a font, a coloured background, a patterned background, a coloured border, and a patterned border.

4. The computer-implemented graphical user interface of claim 1, wherein a second set of said fields is presented in accordance with a layout of search results to be provided in relation to the advertisement when said advertisement satisfies search criteria supplied by a user.

5. The computer-implemented graphical user interface of claim 2, wherein each received value for a field is displayed in a received style, said received style being different from said default style, said received style including at least one of a colour, a font, a coloured background, a patterned background, a coloured border, and a patterned border.

6. The computer-implemented graphical user interface of claim 1, further comprising, for each field, at least one of an editable text field and a popup window for receiving each said received value.

7. A method for receiving content relating to an advertisement in an advertising system, said method comprising the steps of:
creating an advertisement template having a plurality of fields;
pre-populating each field in said advertisement template with a corresponding default value, said default value being selected from the group consisting of: a dummy entry, a description of the field, an example of an entry for the field, and an instruction for completing the field;
storing said advertisement template;
presenting a first set of said fields in an arrangement that corresponds substantially with a publication layout for said advertisement, wherein said arrangement includes at least one of: relative positions of the fields, sizes of the fields, and font of each field;
while at least one of said fields remains pre-populated with said default entry:
displaying said advertisement template;
receiving content in one of said plurality of fields; and
storing said advertisement with said received content as a created advertisement; and
storing said created advertisement with said received content as a complete advertisement.

8. The method according to claim 7, comprising the further step of:
presenting a second set of said fields substantially in accordance with a search results layout.

9. The method according to claim 7, comprising the further step of:
presenting said default values in a default style.

10. The method according to claim 9, wherein said default style includes at least one of a colour, a font, a coloured background, a patterned background, a coloured border, and a patterned border.

11. The method according to claim 9, comprising the further step of:
presenting said received content in a received style, said received style being different from said default style.

12. The method according to claim 11, wherein said received style includes at least one of a colour, a font, a coloured background, a patterned background, a coloured border, and a patterned border.

13. The method according to claim 8, wherein said second set of fields includes fields relating to content to be displayed in a listing of search results, when said advertisement satisfies search criteria supplied by a user.

14. The method according to claim 13, wherein said second set of fields includes a search title field and a search description field.

15. The method according to claim 7, wherein said first set of fields includes at least one of a title field, a description field, a reference number field, and a contact field.

16. The method according to claim 7, comprising the further step of:
publishing said complete advertisement.

17. The method according to claim 16, wherein publishing said complete advertisement includes distributing said complete advertisement to at least one of an agency website and a portal website for publication.

18. The method according to claim 7, wherein said advertisement template is stored as a complete advertisement in response to a user request.

19. The method according to claim to 18, comprising the further step of:
presenting an alert in response to a user request to store said advertisement template as a complete advertisement, when at least one of said fields remains pre-populated with a default entry.

20. The method according to claim 7, wherein receiving content utilises at least one of an editable text box and a popup window.

21. A computer readable storage medium having recorded thereon a computer program for receiving content relating to an advertisement in an advertising system, said computer program comprising code for performing the steps of:
creating an advertisement template having a plurality of fields;
pre-populating each field in said advertisement with a corresponding default value, said default value being selected from the group consisting of: a dummy entry, a description of the field, an example of an entry for the field, and an instruction for completing the field;
storing said advertisement template;
presenting a first set of said fields in an arrangement that corresponds substantially with a publication layout for said advertisement;
while at least one of said fields remains pre-populated with said default entry:
receiving content in one of said plurality of fields; and
storing said advertisement template with said received content as a created advertisement; and
storing said created advertisement with said received content as a complete advertisement.

22. The computer readable storage medium according to claim 21, wherein each of said default values is displayed in a default style.

23. The computer-implemented graphical user interface of claim 22, wherein said default style includes at least one of a colour, a font, a coloured background, a patterned background, a coloured border, and a patterned border.

24. The computer-implemented graphical user interface of claim 22, wherein each received value is displayed in a received style, said received style being different from said default style, said received style including at least one of a colour, a font, a coloured background, a patterned background, a coloured border, and a patterned border.

25. The computer-implemented graphical user interface according to claim 4, wherein said layout of search results includes at least one of a search title field and a search description field.
